(19) United States
(12) Patent Application Publication
(10) Pub. No.: US 2024/0373483 A1
(43) Pub. Date: Nov. 7, 2024

(54) COORDINATED MECHANISM OF ACCESS POINTS WITH DIFFERENT PRIMARY CHANNELS

(71) Applicant: MEDIATEK INC., Hsin-Chu (TW)

(72) Inventor: Chia-Ming Chang, Hsinchu City (TW)

(73) Assignee: MEDIATEK INC., Hsin-Chu (TW)

(21) Appl. No.: 18/650,051

(22) Filed: Apr. 29, 2024

Related U.S. Application Data
(60) Provisional application No. 63/500,053, filed on May 4, 2023.

(51) Int. Cl. H04W 76/10; H04W 72/0453; H04W 74/0816; H04W 84/12

(52) U.S. Cl. CPC H04W 76/10; H04W 72/0453; H04W 74/0816; H04W 84/12

(57) ABSTRACT

The present invention provides a control method of an AP, wherein the control method includes the steps of: establishing a link with at least one station, wherein the link uses a bonded channel including a plurality of Wi-Fi channels, and one of the plurality of Wi-Fi channels serve as a primary channel of the AP; obtaining channel information of another AP, wherein the channel information of the another AP indicates a primary channel of the another AP; and determining if changing the primary channel of the AP according to the primary channel of the another AP, to make the primary channels of the AP and the another AP correspond to different Wi-Fi channels.

### CROSS REFERENCE TO RELATED APPLICATIONS

This application claims the benefit of U.S. Provisional Application No. 63/500,053, filed on May 4, 2023. The content of the application is incorporated herein by reference.

### BACKGROUND

Overlapping basic service set (OBSS) is a problem that reduces the network performance of wireless local area network (WLAN). In overlapping BSS, two or more access points or WLAN stations installed close together and operating on the same Wi-Fi channel that have no connection to each other, but they can receive frames from the neighboring access point or station.

Overlapping BSS occurs much more frequently in broadband WLANs. This is due to the higher bandwidths of 40 MHZ, 80 MHz and 160 MHz as in IEEE 802.11ac, and to the increasing number of WLAN devices competing with each other for radio access. Therefore, how to increase the performance of overlapping access points is an important topic.

### SUMMARY

It is therefore an objective of the present invention to provide a control method of an access point, which can dynamically change a primary channel so that the two access points with OBSS have primary channels corresponding to different Wi-Fi channels to facilitate subsequent negotiation of bandwidth usage, to solve the above-mentioned problems.

According to one embodiment of the present invention, a control method of an AP comprises the steps of: establishing a link with at least one station, wherein the link uses a bonded channel comprising a plurality of Wi-Fi channels, and one of the plurality of Wi-Fi channels serve as a primary channel of the AP; obtaining channel information of another AP, wherein the channel information of the another AP indicates a primary channel of the another AP; and determining if changing the primary channel of the AP according to the primary channel of the another AP, to make the primary channels of the AP and the another AP correspond to different Wi-Fi channels.

According to one embodiment of the present invention, an AP comprising a processing circuit and a wireless communication circuit is disclosed. The wireless communication circuit is configured to perform the steps of: establishing a link with at least one station, wherein the link uses a bonded channel comprising a plurality of Wi-Fi channels, and one of the plurality of Wi-Fi channels serve as a primary channel of the AP; obtaining channel information of another AP, wherein the channel information of the another AP indicates a primary channel of the another AP; and determining if changing the primary channel of the AP according to the primary channel of the another AP, to make the primary channels of the AP and the another AP correspond to different Wi-Fi channels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating two APs and with OBSS according to one embodiment of the present invention.

FIG. 2 is a flowchart of a control method of the AP according to one embodiment of the present invention.

FIG. 3 is a flowchart of a control method of the AP according to one embodiment of the present invention.

FIG. 4 shows the operations of the two APs according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

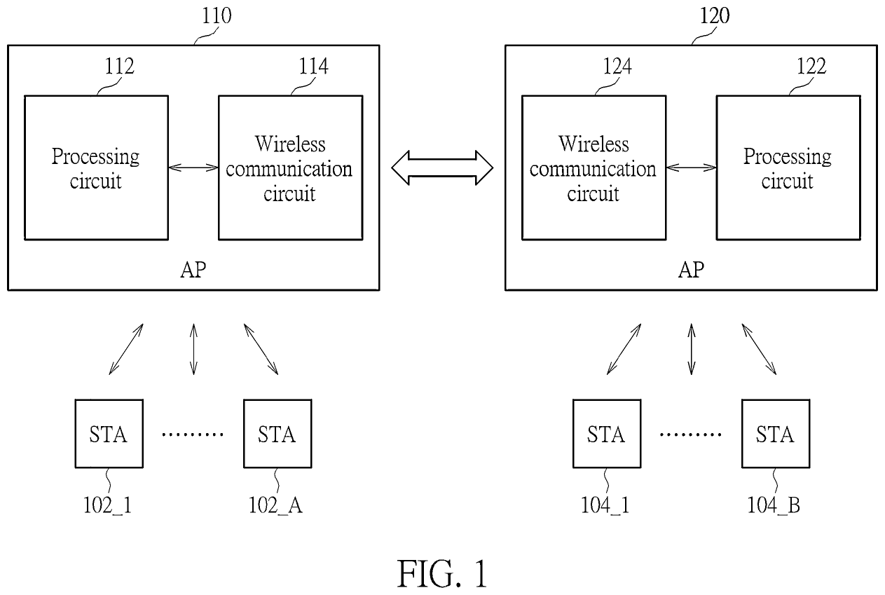

FIG. 1 is a diagram illustrating two APs 110 and 120 with OBSS according to one embodiment of the present invention. As shown in FIG. 1, the AP 110 comprises a processing circuit 112 and a wireless communication circuit 114, wherein the wireless communication circuit 114 comprises at least a media address control (MAC) layer circuit and physical layer circuit, and the AP 110 is configured to wirelessly communicate with at least one station such as stations 102_1-102_A. The AP 120 comprises a processing circuit 122 and a wireless communication circuit 124, wherein the wireless communication circuit 124 comprises at least a MAC layer circuit and physical layer circuit, and the AP 120 is configured to wirelessly communicate with at least one station such as stations 104_1-104_B.

In this embodiment, the AP 110/120 can communicate the corresponding stations by using at least one link, wherein the link may use a channel corresponding to a 2.4 GHz band (e.g., 2.412 GHZ-2.484 GHz), a 5 GHz band (e.g., 4.915 GHz-5.825 GHz) or a 6 GHz band (e.g., 5.925 GHz-7.125 GHz). In addition, each of the APs 110 and 120 uses a channel boning mechanism defined in IEEE 802.11 specification, that is the APs 110 and 120 can bond two or more adjacent Wi-Fi channels (20 MHz channel) to create a wider bandwidth channel to increase the throughput in wireless networks. For example, the AP 110/120 can bond the 20 MHz Wi-Fi channels #36, #40, #44 and #48 to create 80 MHz bandwidth of channel bandwidth; or the AP 110/120 can bond the 20 MHz Wi-Fi channels #36, #40, #44, #48, #52, #56, #60 and #64 to create 160 MHz bandwidth of channel bandwidth; or the AP 110/120 can bond the 20 MHz Wi-Fi channels #100, #104, #108, #112, #116, #120, #124 and #128 to create 160 MHz bandwidth of channel bandwidth.

When the AP 110/120 performs the channel bonding mechanism to have a wider channel bandwidth such as 40 Hz, 80 MHz or 160 MHz, the AP 110/120 needs to set a primary channel and at least one secondary channel for the bonded channel, wherein the primary channel is configured to transmit management packets such as beacon frames, and the primary channel and the secondary channel(s) are used to transmit data frames. For example, if the AP 110 bonds the 20 MHz Wi-Fi channels #36, #40, #44, #48, #52, #56, #60 and #64 to create 160 MHz bandwidth of channel bandwidth, the AP 110 may select Wi-Fi channel #36 as the primary channel, and the other Wi-Fi channels are secondary channels. In addition, when the AP 110/120 transmits or receive frames, it's primary channel must be clean and cannot be occupied by the other devices.

When both the APs 110 and 120 use the channel bonding mechanism, there is a chance that the APs will have the same bonded channel. In addition, if the APs 110 and 120 installed close together, each of the APs 110 and 120 can receive frames from the neighboring AP, and these frames from the neighboring AP may cause interference to its own operations. In this embodiment, the APs 110 and 120 are regarded as the OBSS APS.

In order to solve the above-mentioned problems, the following embodiments provide a collaboration mechanism of the OBSS APs to make the AP 110/120 use the bonded channels efficiently. In order to facilitate the following description, the AP 110 is used as the main description object, while the AP 120 serves as the OBSS AP for the AP 110.

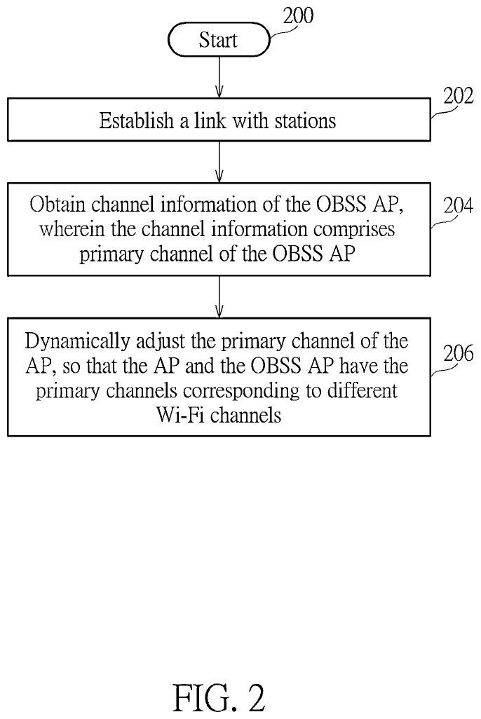

FIG. 2 is a flowchart of a control method of the AP 110 according to one embodiment of the present invention, wherein the control method may be executed by the wireless communication circuit 114. In Step 200, the flow starts, and the AP 110 is powered on and perform the initialization processes. In Step 202, the AP 110 establishes at least one link with the station(s) 102_1-102_A with the channel bonding mechanism, wherein the at least one link use a bonded channel having two or more 20 MHz Wi-Fi channels.

In Step 204, the AP 110 obtains channel information of the AP 120, wherein the channel information of the AP 120 comprises primary channel information of the AP 120. In one embodiment, the wireless communication circuit 114 of the AP 110 can listen/detect all the Wi-Fi channels within the bonded channel to determine if the primary channel of the AP 120 is located within these channels. For example, assuming that the bonded channel of the AP 110 comprises eight Wi-Fi channels #36, #40, #44, #48, #52, #56, #60 and #64, the wireless communication circuit 114 can detect the energy of these eight Wi-Fi channels, or perform a packet detection on these eight Wi-Fi channels, to determine if one of the these eight Wi-Fi channels has high energy or has a beacon sent from the AP 120, to determine if the primary channel of the AP 120 is located within these eight Wi-Fi channels.

In one embodiment, the above channel information may be carried in at least part the beacon frames, and the AP 120 can send this beacon having the channel information by using a non-HT (non-high throughput) duplicate mechanism to duplicate a 20 MHZ non-HT transmission in all Wi-Fi channels within the bonded channel. For example, the AP 120 transmits the normal beacon frames (i.e., without the above channel information) with a beacon period of 100 ms by only using its primary channel, some specific beacon frames (e.g., one of every ten beacon frames) carrying the channel information of the AP 120 can be transmitted under the non-HT duplicate mechanism (i.e., all the Wi-Fi channels within the bonded channel). That is, the specific beacon frames carrying the channel information of the AP 120 are transmitted with larger beacon period such as 1 second, while the normal beacon frames are transmitted with smaller beacon period such as 100 ms.

In another embodiment, the APs 110 and 120 may establish another link so that the APs 110 and 120 can exchange their channel information, that is the AP 110 directly receives the channel information from the AP 120.

In Step 206, the AP 110 dynamically adjusts its primary channel so that the APs 110 and 120 do not use the same Wi-Fi channel as the primary channel. For example, if the AP 110 uses the Wi-Fi channel #64 as the primary channel, and the AP 110 receives the channel information of the AP 120 indicating that the AP 120 also uses the Wi-Fi channel #64 as the primary channel, the AP 110 can change its primary channel to any other Wi-Fi channel within the bonded channel, such as Wi-Fi channel #36 or #40, at any appropriate time. In another example, if both the APs 110 and 120 uses the Wi-Fi channel #64 as the primary channel, the AP 110 can reestablish a link to use another bonded channel that does not comprise the Wi-Fi channel #64, and select any one Wi-Fi channel of the new bonded channel as the primary channel. In addition, if the APs 110 and 120 do not have the same primary channel from the beginning, the AP 110 may not change the primary channel, or the AP 110 can change its primary channel so that the primary channels of the APs 110 and 120 have larger frequency difference.

In addition, when the AP 110 determines to change its primary channel, the AP 110 can use a channel switch announcement (CSA) mechanism in the IEEE 802.11 specification, or use any suitable protocol, to finish the primary channel switch operation.

In the embodiment shown in FIG. 2, by controlling the APs 110 and 120 to have primary channels corresponding to different Wi-Fi channels, the AP 110 is less likely to be interfered by the AP 120, and it can also facilitate subsequent wireless transmission operations in this embodiment to improve the efficiency of the AP 110.

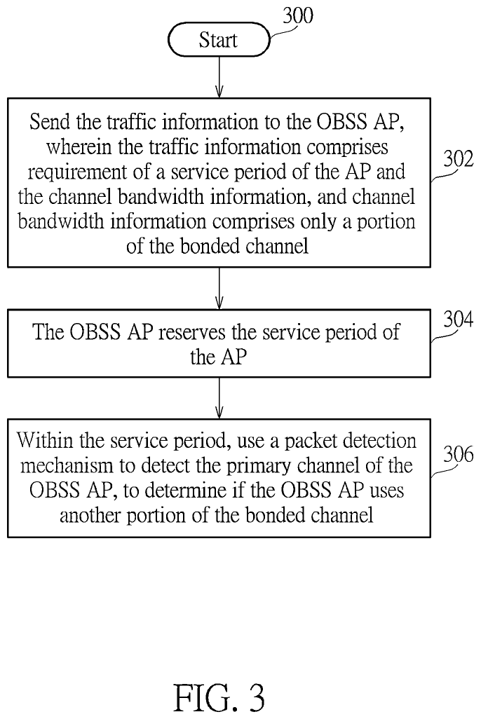

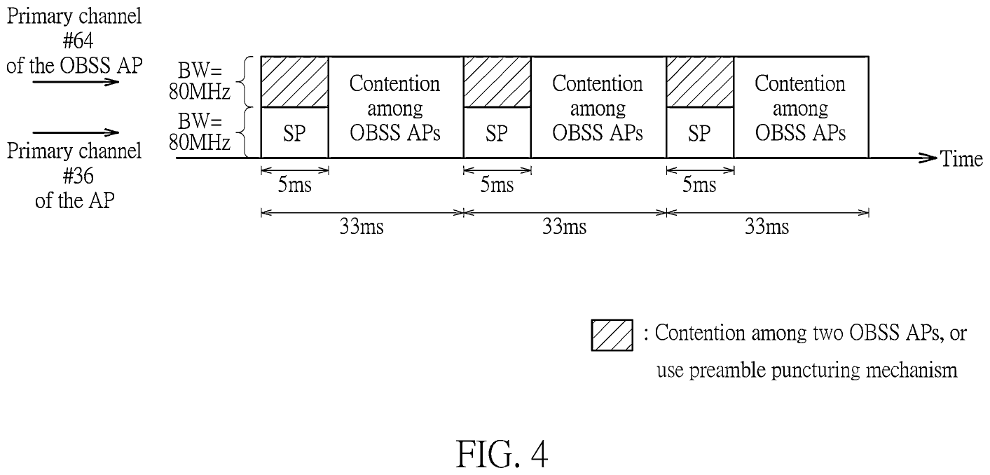

FIG. 3 is a flowchart of a control method of the AP 110 according to one embodiment of the present invention, wherein the flowchart shown in FIG. 3 can be continued from Step 206 in FIG. 2. In Step 300, the flow starts, and the APs 110 and 120 do not have the same primary channels. To facilitate the following descriptions, referring to FIG. 4 together, the APs 110 and 120 have the same bonded channel with 160 MHz bandwidth comprising the Wi-Fi channels #36, #40, #44, #48, #52, #56, #60 and #64, the AP 110 uses the Wi-Fi channel #36 as the primary channel, and the AP 120 uses the Wi-Fi channel #64 as the primary channel. In Step 302, the AP 110 sends the traffic information to the AP 120, wherein the traffic information comprises requirement of a service period (SP) of the AP 110, and the channel bandwidth information used for the SP, wherein the channel bandwidth information may comprise at least a portion of the Wi-Fi channels within the bonded channel. In one embodiment, referring to FIG. 4 together, the SP is a period SP, and the traffic information sent by the AP 110 comprises a transmission period such as 33 milliseconds (ms), a SP such as 5 ms within the transmission period, a start time of the service period (e.g., at a beginning of each transmission period), a channel bandwidth used for the SP, and access class (AC) priority.

The SP is set for the AP 110 to transmit time-sensitive data, such as gaming data. In addition, in order to make all the APs have the good services, the SP does not occupy all the Wi-Fi channels within the bonded channel. Taking FIG. 4 as an example, a portion of the bonded channel, such as the lower 80 MHz comprising Wi-Fi channels #36, #40, #44 and #48, is used for the SP in the traffic information, and the upper 80 MHz comprising Wi-Fi channels #52, #56, #60 and #64 does not included in the traffic information.

The AP 110 may use any suitable handshake protocol to send the traffic information to the AP 120. In one embodiment, the AP 110 may use the duplicate mechanism to transmit the traffic information to make sure that the AP 120 can get this traffic information. Specifically, the AP 110 duplicates a 20 MHz non-HT transmission in all Wi-Fi channels within the bonded channel.

In one embodiment, the traffic information may be carried in at least part the beacon frames, and the non-HT duplicate mechanism can be applied to part of the beacon frames. For example, the normal beacon frames are transmitted with a beacon period of 100 ms by using only the primary channel #36, some specific beacon frames (e.g., one of every ten beacon frames) carrying the traffic information of the AP 110 can be transmitted under the non-HT duplicate mechanism. That is, the specific beacon frames carrying the traffic information of the AP 110 are transmitted with larger beacon period such as 1 second, while the normal beacon frames are transmitted with smaller beacon period such as 100 ms.

In Step 304, the AP 120 reserves the SP for the AP 110. Specifically, during the SP shown in FIG. 4, the AP 120 can use orthogonal frequency division multiple access (OFDMA), quiet period setting, preamble puncturing mechanism, a clear to send (CTS) to self (CTS2SELF) operation, or any other suitable method to prevent the stations 104_1-104_B from transmitting packets using the reserved Wi-Fi channels (i.e., lower 80 MHz shown in FIG. 4) during the SPs.

In Step 306, during the packet transmission of the AP 110, the AP 110 can use a packet detection mechanism to detect the primary channel of the AP 120, to determine if the AP 120 uses another portion of the bonded channel, such as the upper 80 MHZ comprising Wi-Fi channels #52, #56, #60 and #64 to transmit data. If it is determined that the AP 120 does not use the other portion of the bonded channel now, the AP 110 can use the other portion of the bonded channel by using the conventional medium contention protocol and backoff procedure descried in the IEEE 802.11 specification to minimize the probability of a subsequent collision. In addition, during the SP, if the AP 110 wants to use the other portion of the bonded channel (e.g., the upper 80 MHz shown in FIG. 4), the AP 110 may use a preamble puncturing mechanism in IEEE 802.11ax to blank one or more Wi-Fi channels, wherein the one or more Wi-Fi channels comprise the primary channel of the AP 120.

In addition, in intervals other than the SP, the APs 110 and 120 can use the conventional medium contention protocol and backoff procedure to transmit frames.

Briefly summarized, in the control method of the AP 110 of the above embodiments, the AP 110 can change its primary channel when the AP 120 (i.e., OBSS AP) exists and both AP 110 and 120 use the same primary channel, to facilitate subsequent wireless transmission operations. In addition, the AP 110 can handshake with the AP 120 to reserve a service period that only occupies a portion of the bonded channel (i.e., a portion of bandwidth), to make the AP 120 not use the full channel bandwidth during the service period, so that the AP 110 can have better performance for the time-sensitive traffic. In addition, by using the packet detection mechanism instead of the conventional energy detection specified in IEEE 802.11 to detect the primary channel of the AP 120, the AP 110 can use the other portion of the bonded channel during the service period.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an access point (AP), comprising:
establishing a link with at least one station, wherein the link uses a bonded channel comprising a plurality of Wi-Fi channels, and one of the plurality of Wi-Fi channels serve as a primary channel of the AP;
obtaining channel information of another AP, wherein the channel information of the another AP indicates a primary channel of the another AP; and
determining if changing the primary channel of the AP according to the primary channel of the another AP, to make the primary channels of the AP and the another AP correspond to different Wi-Fi channels.

2. The control method of claim 1, wherein the step of obtaining the channel information of the another AP comprises:
detecting all of the plurality of Wi-Fi channels within the bonded channel to determine the primary channel of the another AP.

3. The control method of claim 1, wherein the step of obtaining the channel information of the another AP comprises:
directly receiving the channel information from the another AP.

4. The control method of claim 1, further comprising:
sending traffic information to the another AP, wherein the traffic information comprises requirement of a service period of the AP and corresponding channel bandwidth information.

5. The control method of claim 4, wherein the traffic information sent by the AP comprises a transmission period, the service period within the transmission period, a start time of the service period and a channel bandwidth used for the service period.

6. The control method of claim 4, wherein the channel bandwidth information comprised in the traffic information indicates a portion of the plurality of Wi-Fi channels within the bonded channel, and the portion of the plurality of Wi-Fi channels does not comprise the primary channel of the another AP.

7. The control method of claim 6, further comprising:
performing a packet detection on the primary channel of the another AP to determine if the another AP uses another portion of the plurality of Wi-Fi channels within the bonded channel; and
if the another AP does not use the another portion of the plurality of Wi-Fi channels within the bonded channel, using the another portion of the plurality of Wi-Fi channels to transmit packet(s).

8. The control method of claim 4, wherein the step of sending the traffic information to the another AP comprises:
using a non-high throughput (non-HT) duplicate mechanism to transmit the traffic information at the plurality of Wi-Fi channels.

9. The control method of claim 4, wherein the step of sending the traffic information to the another AP comprises:
sending the traffic information to the another AP, for the another AP to use an orthogonal frequency division multiple access (OFDMA), a quiet period setting, a preamble puncturing mechanism or a clear to send (CTS) to self (CTS2SELF) operation to prevent station(s) of the another AP from transmitting packets using Wi-Fi channels of the corresponding channel bandwidth information during the service period.

10. An access point (AP), comprising:
a processing circuit; and
a wireless communication circuit;
wherein the wireless communication circuit is configured to perform the steps of:
establishing a link with at least one station, wherein the link uses a bonded channel comprising a plurality of Wi-Fi channels, and one of the plurality of Wi-Fi channels serve as a primary channel of the AP;
obtaining channel information of another AP, wherein the channel information of the another AP indicates a primary channel of the another AP; and
determining if changing the primary channel of the AP according to the primary channel of the another AP, to make the primary channels of the AP and the another AP correspond to different Wi-Fi channels.

11. The AP of claim 10, wherein the step of obtaining the channel information of the another AP comprises:
detecting all of the plurality of Wi-Fi channels within the bonded channel to determine the primary channel of the another AP.

12. The AP of claim 10, wherein the step of obtaining the channel information of the another AP comprises:
directly receiving the channel information from the another AP.

13. The AP of claim 10, further comprising:
sending traffic information to the another AP, wherein the traffic information comprises requirement of a service period of the AP and corresponding channel bandwidth information.

14. The AP of claim 13, wherein the traffic information sent by the AP comprises a transmission period, the service period within the transmission period, a start time of the service period and a channel bandwidth used for the service period.

15. The AP of claim 13, wherein the channel bandwidth information comprised in the traffic information indicates a portion of the plurality of Wi-Fi channels within the bonded channel, and the portion of the plurality of Wi-Fi channels does not comprise the primary channel of the another AP.

16. The AP of claim 15, further comprising:
performing a packet detection on the primary channel of the another AP to determine if the another AP uses another portion of the plurality of Wi-Fi channels within the bonded channel; and
if the another AP does not use the another portion of the plurality of Wi-Fi channels within the bonded channel, using the another portion of the plurality of Wi-Fi channels to transmit packet(s).

17. The AP of claim 13, wherein the step of sending the traffic information to the another AP comprises:
using a non-high throughput (non-HT) duplicate mechanism to transmit the traffic information at the plurality of Wi-Fi channels.

18. The control method of claim 13, wherein the step of sending the traffic information to the another AP comprises:
sending the traffic information to the another AP, for the another AP to use an orthogonal frequency division multiple access (OFDMA), a quiet period setting, a preamble puncturing mechanism or a clear to send (CTS) to self (CTS2SELF) operation to prevent station(s) of the another AP from transmitting packets using Wi-Fi channels of the corresponding channel bandwidth information during the service period.
